(19) United States
(12) Patent Application Publication
(10) Pub. No.: US 2022/0156683 A1
(43) Pub. Date: May 19, 2022

(54) SUPPLY CHAIN MONITORING

(71) Applicant: Target Brands, Inc., Minneapolis, MN (US)

(72) Inventors: Venkata Rao Putrevu, Maple Grove, MN (US); Jacob Michael Melvin Luby, Plymouth, MN (US); Derek Andrew Olk, Maple Grove, MN (US); Rachel Alderman, Hanover, MN (US)

(21) Appl. No.: 16/951,453

(22) Filed: Nov. 18, 2020

(51) Int. Cl. G06Q 10/08; G06F 16/2455; G06F 12/02

(52) U.S. Cl. CPC G06Q 10/087; G06F 2212/251; G06F 12/0238; G06F 16/24556

(57) ABSTRACT

A computer-implemented method includes receiving values for different keys from different systems in a supply chain and determining a difference between a value for a first key from a first system and a value for a second key from a second system and comparing the difference to an alert threshold. An alert is issued when the difference exceeds the alert threshold.

### BACKGROUND

A supply chain is a sequence of operations that take an item from a supplier and deliver the item to an end user. Operations in a supply chain include setting desired levels of inventory for the item at one or more locations along the supply chain, issuing order requests to entities in the supply chain to request additional units of an item to reach the desired inventory level, converting the order requests into transfer orders that designate a number of units and a destination for the units, adjusting the transfer orders based on a number of units available to the shipping entity, creating shipments by combining different transfer orders for different items, picking and combining the items assigned to a shipment and placing those items in a shipping container for transport, transporting the shipment to another location along the supply channel, and inspecting and acknowledging receipt of items received in a shipment.

Within a supply chain, each of the operations must be performed for a large number of items coming from a large number of suppliers and destined for a large number of end locations every day. In order to cope with the volume of items being handled each day, distinct systems have been developed to handle each step along the supply chain. For example, a replenishment engine generates order requests based on desired inventory levels, current inventory levels and predictions for changes in inventory that will occur before the order request can be fulfilled. On the other hand, a completely different system takes in adjusted transfer orders, identifies orders that are going to the same location and creates shipments that must efficiently use shipping containers to minimize the expense associated with shipping while ensuring that items reach their destination in an acceptable amount of time.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes receiving values for different keys from different systems in a supply chain and determining a difference between a value for a first key from a first system and a value for a second key from a second system and comparing the difference to an alert threshold. An alert is issued when the difference exceeds the alert threshold.

In accordance with further embodiments, a supply chain monitoring system includes a message intake accessing key/value pairs generated by a plurality of systems in a supply chain for purposes other than monitoring the supply chain and a data storage system storing the key/value pairs in a random access memory. An alert service requests values from the random access memory and uses the requested values to determine whether key/value pairs from a first system in the plurality of systems and key/value pairs from a second system in the plurality of systems indicate that an alert condition exists in the supply chain.

In accordance with a still further embodiment, a method includes storing data in random access memory from multiple systems in a supply chain and executing an alert service that sets an alert when one of the multiple systems has not provided key/value pairs associated with a supply chain process performed by the system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a supply chain monitoring system.

FIG. 2 is an expanded block diagram of a portion of the supply chain monitoring system of FIG. 1.

FIG. 3 provides a flow diagram of one method of identifying whether a low shipment value for a distribution center is an error and if it is an error, which system introduced the error.

FIG. 4 provides an example user interface showing unit quantities for a number of different destinations.

FIG. 5 provides an example user interface showing the number of units shipped to a destination on each day.

FIG. 6 provides an example user interface showing the number of units for OTL, order requests, transfer orders and shipments for the past thirty days for a destination.

FIG. 7 provides a flow diagram of a method of identifying which department of a destination has received erroneous data.

FIG. 8 provides an example user interface showing destination-level unit quantities associated with order requests produced by replenishment engines.

FIG. 9 provides an example user interface showing unit quantities for individual departments.

FIG. 10 provides a block diagram of a computing system that implements the various embodiments.

### DETAILED DESCRIPTION

The different systems used within a supply chain are incapable of identifying when a system earlier in the supply chain has malfunctioned. While users of a system may identify unusual values being sent from an earlier system, the users cannot be sure that the unusual data is erroneous and cannot determine where the error may have occurred within the supply chain. As a result, when an error occurs, the error is often ignored by later systems causing the supply chain to fail to provide needed items or causing the supply chain to provide items that are not needed. When an unusual value is detected, an investigation of the supply chain is initiated to determine if the unusual value is an error and where the error originated in the supply chain. Such investigations are time consuming and require accessing many systems to trace back how the value was generated.

The embodiments described below provide a supply chain monitoring system that modifies streams of information provided by different systems in the supply chain into a common framework that allows an alert service to compare the published key/value pairs from one system with published key/value pairs of other systems in the supply chain and to issue alerts based on the comparisons. The monitoring system is also able to issue alerts based on comparisons of key/value pairs provided at one time to key/value pairs provided at another time and to issue alerts when a system does not publish key/value pairs by a certain time. To perform the comparisons, the values in some of the key/value pairs are aggregated so that the compared values represent a same level of unit counts such as at the distribution center level, the destination location level, or the department level within a location. The monitoring system also provides user interface systems that generate user interfaces to show how values for different keys from different systems compare to each other over time and to show how values for a key for different locations or for a location at different times compare to each other.

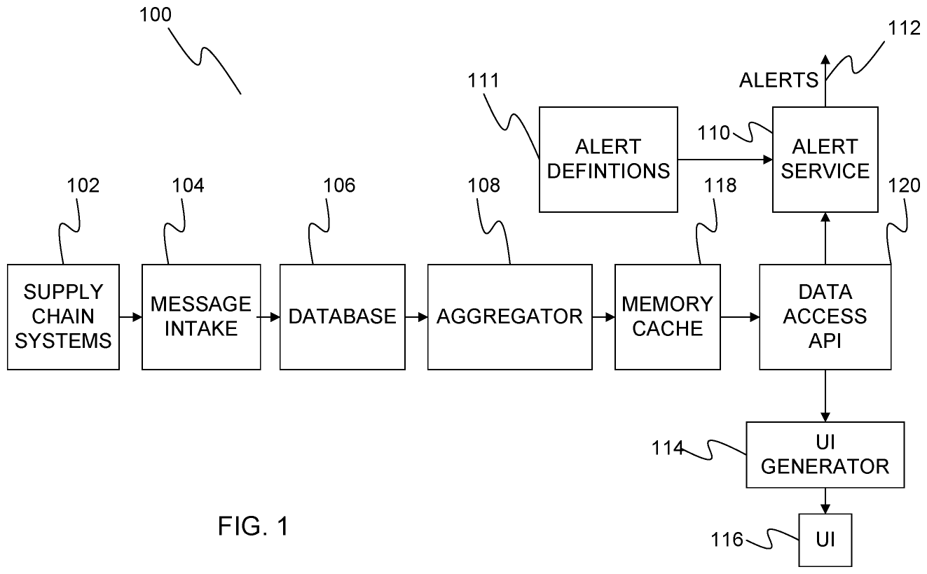

FIG. 1 provides a block diagram of a supply chain monitoring system 100 for monitoring supply chain systems 102. Monitoring system 100 includes a message intake 104 that captures messages containing key/value pairs generated by the various systems in supply chain systems 102. The messages generated by the various supply chain systems are not produced so as to enable supply chain monitoring but instead are produced for other purposes such as conveying information from one system in the supply chain to the next system in the supply chain. The key/value pairs included in any one message are at the discretion of the system providing the message. Message intake 104 stores the information provided in those messages in a database 106. An aggregator 108, aggregates the data in database 106 and stores the aggregated data in a memory cache 118 that is maintained in Random Access Memory for fast access. Components, such as user interface generators 114 and alert service 110 use a data access API 120 to request data stored in memory cache 118.

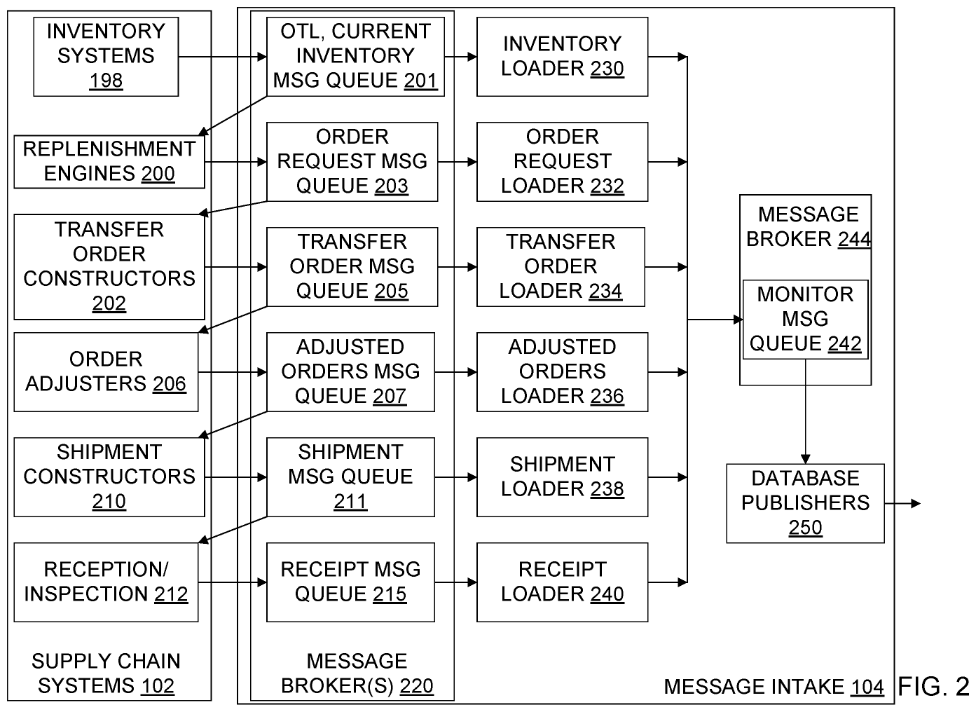

FIG. 2 provides an expanded version of supply chain systems 102 and message intake 104. As shown in FIG. 2, supply chain systems 102 include a collection of systems that work in sequence to cause inventory to move between various locations of a supply chain. As discussed further below, each of the systems in supply chain systems 102 receives and publishes supply chain information through message broker message queues provided on one or more message broker(s) 220, such as Kafka message brokers. The messages are placed on the message queues so that systems that are further down the supply chain can perform their supply chain functions. This produces a stream of messages that flow between the various systems of the supply chain in order to trigger movement of the inventory between various locations of the supply chain.

The stream of messages that flow between the various systems begins with inventory systems 198 posting messages to an inventory message queue 201 on message brokers 220. These messages include key/value pairs representing desired inventory levels (OTL), current inventory levels, and inventory adjustments such as recalls for each of a plurality of items at each of a plurality of locations.

Replenishment engines 200 request the messages on inventory message queue 201. Using prediction models and the input inventory information from the messages, replenishment engines 200 determine the items that need to be ordered for each of a collection of locations. When a location needs more units of an item, replenishment engines 200 generate a transfer order request for the location. These transfer order requests are then published on an order request message queue 203. In accordance with one embodiment, replenishment engine 200 publishes a separate message on order request message queue 203 for each transfer order request with each message containing key/value pairs that provide an identifier for the item to be ordered, the number of units of the item in the transfer order request, the location that is to receive the items and in some cases, the department in which the item is found. Additional messages may be published by replenishment engines 200 indicating higher-level metrics such as the number of units requested in response to triggers from destinations and the number of units requested in response to a trigger from headquarters. In many embodiments, multiple instances of replenishment engines 200 run in parallel.

Transfer order constructors 202 request messages from order request message queue 203 and for each message, validate the order request and determine if a time specified for the transfer has arrived. If the time has arrived, transfer order constructor 202 publishes a message representing a transfer order on a transfer order message queue 205. The message includes key/value pairs that provide an identifier for the transfer order, the identifier for the item, the number of units of the item to be transferred, the current location of the units and the destination for the units.

Order adjusters 206, request messages from transfer order message queue 205 and access a current inventory level for the item in a distribution center to determine if there are enough units of the item in the distribution center to satisfy the transfer order. Order adjusters 206 then generate an adjusted transfer order that contains the number of units that can actually be transferred. For each adjusted transfer order that is produced, order adjusters 206 publish a message on adjusted order message queue 207. Each message includes key/value pairs indicating the identifier for the order, the identifier for the item, the location of the items, the destination for the items, the number of units in the initial transfer order, the number of units in the adjusted transfer order and the number of units (if any) that the location was unable to provide for the original transfer order.

Shipment constructors 210 request messages from adjusted order message queue 207 and combine the different transfer orders into shipments to destinations. In particular, all of the transfer orders placed in a shipment are for the same destination and are to be sent on the same date. For each shipment, shipment constructors 210 publishes a message on shipment message queue 211. Each message includes key/value pairs that provide an identifier for the shipment, the identifiers for the adjusted transfer orders that are assigned to the shipment, the items in the shipment and for each item, the number of units of the item in the shipment as well as the destination for the shipment.

Reception/inspection systems 212 are used when a shipment is received at a destination. Using the reception/inspection systems, a worker at the destination confirms the number of units of each item received and indicates any damaged units that were received. For each item received in a shipment, reception/inspection system 212 posts a message on receipts message queue 215 that includes key/value pairs indicating an identifier for the shipment, an identifier for the adjusted transfer order that was received in the shipment, an identifier for the item, the number of units of the item received, the number of units of the item that were damaged, and the time and date when the items were received.

Message intake 104 taps into the stream of messages produced by the various systems of supply chain systems 102 in order to monitor the health and behavior of the supply chain. To do this, message intake 104 includes a set of loaders 230, 232, 234, 236, 238 and 240 that request messages from message queues 201, 203, 205, 207, 211 and 215, respectively. For each message that a loader 230, 232, 234, 236, 238 and 240 receives, the loader publishes a corresponding message on a monitor message queue 242 on a message broker 244. Thus, each of loaders 230, 232, 234, 236, 238 and 240 publish on the same monitor message queue 242.

As noted above, each system in supply chain systems 102 places messages on message broker 220 to provide information to the next system in the supply chain. The messages are not placed on message broker 220 to determine the overall health of the supply chain or to identify problems in the supply chain. By requesting the messages that supply chain systems 102 are placing on message brokers 220 for other purposes, loaders 230, 232, 234, 236, 238 and 240 are able to obtain metrics for the overall health of the supply chain without placing any additional computational loads on supply chain systems 102.

Because supply chain systems 102 place messages on message brokers 220 for purposes other than determining the overall health of the supply chain, the keys used by the various supply chain systems are not always consistent with each other. For example, an identifier for an order may be represented by the key: ORDER in messages generated by one supply chain system but may be represented by the key: ORDERID in messages generated by another supply chain system. To address this, when creating the message to be published on monitor message queue 242, loaders 230, 232, 234, 236, 238 and 240 alter each message that is received from message brokers 220 by replacing any keys that do match a set of keys designated for monitoring system 100. For example, if monitoring system 100 uses “ITEMID” as the key for the item identifier, any key for the item identifier that is different from “ITEMID” is replaced with “ITEMID”.

In further embodiments, loaders 230, 232, 234, 236, 238 and 240 may not include all of the information found in a message from message brokers 220 when publishing a corresponding message to monitor message queue 242. By removing information that is not needed to monitor the operation of the supply chain, the loader is able to reduce the bandwidth of information handled by message broker 244, thereby improving the operation of monitoring system 100.

Message intake 104 further includes one or more database publishers 250 that request messages from monitor message queue 242 and load the information contained in the messages into database 106. In some embodiments, multiple types of databases 106 may be provided, each with a corresponding database publisher 250 that requests messages from monitor message queue 242.

Returning to FIG. 1, with each update to database 106 or on a periodic basis, aggregator 108 updates aggregated data stored in memory cache 118 based on the changes to database 106. In particular, for each message involving an order request, aggregator 108 updates a respective daily unit count for order requests for the location that will receive the units in the order request, the location's department that will receive the units in the order request, and the distribution center that will process the units in the order request. For each message involving a transfer order, aggregator 108 updates a respective daily unit count for transfer orders for the location that will receive the units in the transfer order, the location's department that will receive the units in the transfer order, and the distribution center that will process the units in the transfer order. For each message involving an order adjustment, aggregator 108 updates a respective daily unit count for order adjustments for the location that will receive the units in the order adjustment, the location's department that will receive the units in the order adjustment, and the distribution center that will process the units in the order adjustment. For each message involving a shipment, aggregator 108 updates a respective daily unit count for shipments for the location that will receive the units in the shipment, the location's departments that will receive the units in the shipment, and the distribution center that will process the units in the shipment.

Data access API 120 provides access to the data in memory cache 118. Because memory cache 118 is stored in Random Access Memory, data access API 120 is able to access the data and return the data quickly to requesting services. In accordance with one embodiment, one client that uses data access API 120 is alert service 110, which compares the data in memory cache 118 to one or more alert definitions 111 to determine if an alert 112 should be issued for the supply chain. Examples of alert definitions include temporal alert definitions that determine whether individual systems in supply chain systems 102 have completed various jobs by designated times for the jobs.

For example, in accordance with some embodiments, a temporal alert is set to determine if an order request has been received for each destination in an enterprise by a set time. When no order requests are received for a destination by the set time, alert service 110 issues an alert 112 to trigger an investigation of the replenishment engines and/or the systems that provide input to the replenishment engines to determine why an order request was not generated for the location.

Other alert definitions test for anomalies within the order request key/value pairs. Examples of such anomalies include large changes in the number of units ordered for a location compared to a prior day or compared to an average of prior days, or large differences between the number of units ordered for one location compared to the number of units ordered for another location. In accordance with one alert test, a difference between the aggregate number of units of all items in all order requests for a location for the current day and the aggregate number of units of all items in all order requests for the location for a prior day is determined. The difference is then compared to an alert threshold such that if the difference is greater than the threshold, an alert is issued. This alert test can be performed even when the replenishment engines are incapable of performing such a test.

In accordance with another alert test, the difference between the aggregate number of units of all items in order requests for a first location for the current day and the aggregate number of units of all items in order requests for a second location for the current day is determined. This difference is compared to an alert threshold such that if the difference is greater than the alert threshold, an alert is issued.

In other alert definitions 111, a time is set to test for missing transfer orders. The time is set based on an expected time that all transfer order constructor jobs 202 are to have completed. When triggered, alert service 110 uses data access API 120 to search memory cache 118 to determine if transfer orders have been received for each destination that receives items on a daily basis. In accordance with one embodiment, alert service 110 sets an alert for each destination for which a transfer order has not been received. When a transfer order is not received for a destination, the transfer order constructor systems and/or the systems that provide input to the transfer order constructors need to be investigated to determine why a transfer order was not generated for the location.

In other embodiments, alert definitions 111 include definitions that identify anomalies within the transfer order key/value pairs. Examples of such anomalies include large changes in the number of units ordered for a location compared to a prior day or compared to an average of prior days, or large differences between the number of units ordered for one location compared to the number of units ordered for another location. In accordance with one alert definition, the difference between the number of units of all items in order requests for a location for the current day and the number of units of all items in order requests for the location for a prior day is determined and the difference is compared to an alert threshold such that if the difference is greater than the threshold, an alert is issued. This alert test can be performed even when the transfer order constructors are incapable of performing such a test. In accordance with another alert definition, the difference between the number of units of all items in order requests for a first location for the current day and the number of units of all items in order requests for a second location for the current day is determined. The difference is compared to an alert threshold such that if the difference is greater than the alert threshold, an alert is issued.

In still further embodiments, alert definitions 111 include a definition that compares the number of units of items associated with transfer order requests to the number of units of items associated with transfer orders. In one embodiment, this test involves determining the difference between the aggregate number of units of all items across all transfer order requests for a particular distribution center and the aggregate number of units of all items across all transfer orders for the particular distribution center. When the difference exceeds an alert threshold, alert service 110 issues an alert. This alert test allows values for different keys, transfer order request units and transfer order units, from different systems in the supply chain to be compared to each other.

Other alert definitions 111 identify anomalies within the shipment key/value pairs. Examples of such anomalies include large changes in the number of units shipped to a location today compared to a prior day or compared to an average of prior days, or large differences between the number of units shipped to one location compared to the number of units shipped to another location. In accordance with one alert definition, the difference between the number of units of all items in all shipments for a location for the current day and the number of units of all items in all shipments to the location for a prior day is determined. When the difference is greater than an alert threshold, an alert is issued. This alert test can be performed even when the shipment constructors are incapable of performing such a test. In accordance with another alert definition, the difference between the number of units of all items in all shipments to a first location for the current day and the number of units of all items in all shipments to a second location for the current day is determined. When the difference is greater than an alert threshold, an alert is issued.

Other alert definitions compare the number of units of items associated with adjusted transfer orders to the number of units of items associated with shipments. In one embodiment, this test involves determining the difference between the number of units of all items across all adjusted transfer orders for a particular distribution center for the day and the number of units of all items across all shipments for the particular distribution center for the day. When the difference exceeds an alert threshold, alert service 110 issues an alert. This alert test allows values for different keys, adjusted transfer order units and shipment units, from different systems in the supply chain to be compared to each other.

Although specific alert definitions are discussed above, these are only exemplary definitions. In other definitions, values for other keys are compared to each other, either directly or in aggregate, to determine if an alert condition exists in the supply chain. The exemplary definitions are shown to explain that alert service 110 is able to perform monitoring tests that individual systems are incapable of performing on their own. In particular, alert service 110 is able to compare values for different keys from different systems in order to determine whether an alert condition exists in the supply chain.

User interface generator 114 also uses data access API 120 to obtain information about supply chain systems 102. User interface generator 114 uses this information to generate a number of user interfaces 116 that can be used to identify when a data anomaly is due to an error and what system introduced the error into the supply chain.

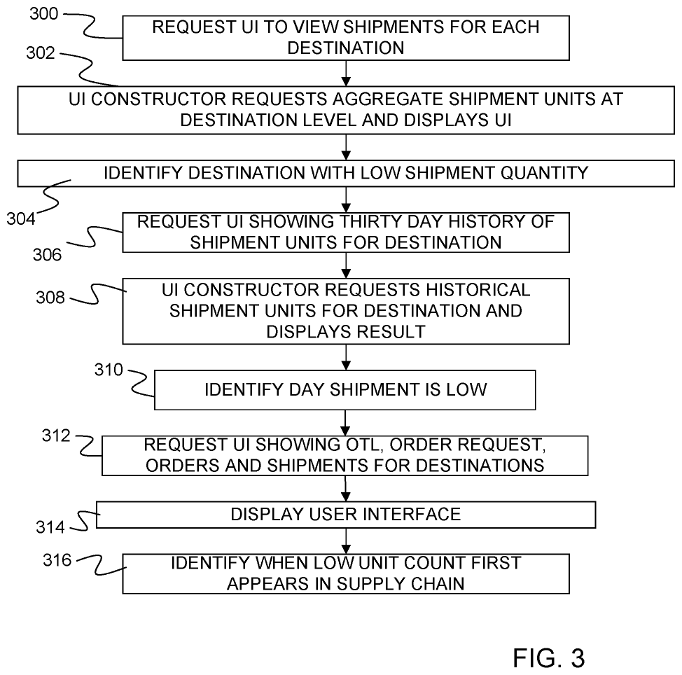

FIG. 3 provides a flow diagram of one method of identifying whether a low shipment value for a distribution center is an error and if it is an error, which system introduced the error.

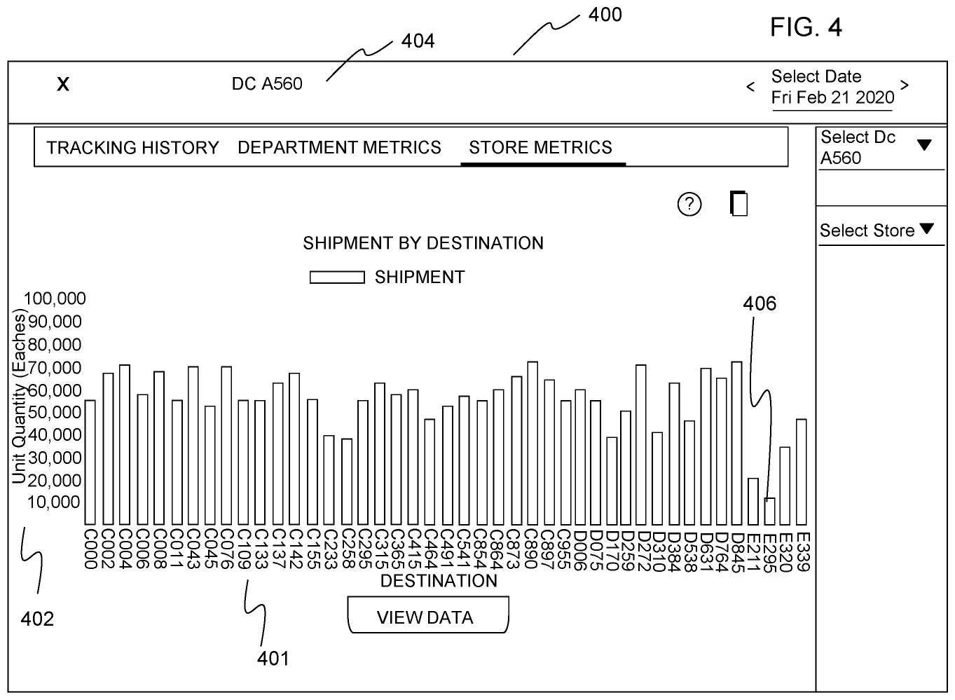

At step 300, a user requests that user interface generator 114 generate a user interface to show all shipments for the current day from a particular distribution center broken down by shipment destination. At step 302, user interface generator 114 sends a request to data access API 120 for separate total shipped unit counts for each shipment destination from the distribution center. User interface generator 114 then displays a graph showing a separate bar for each destination, where each bar indicates the total number of units across all items that were shipped to the destination. FIG. 4 provides an example of a user interface 400 showing shipment destinations along horizontal axis 401 and total number of shipped units along vertical axis 402. A header 404 indicates which distribution center created the shipments. In FIG. 4, it can be seen that destination 406 has a small number of units in its shipments. At step 304, this destination is identified as being a possible cause of the low shipment total for the distribution center.

At step 306, the user requests that user interface generator 114 provide a user interface showing a thirty-day history of shipments for the destination to determine if today's shipments are unusual for the destination.

At step 308, user interface generator 114 sends a request to data access API 120 for the aggregate quantity of units shipped to the destination for each of the previous thirty days. User interface generator 114 receives the aggregate values and then displays a user interface showing the number of units shipped to the destination on each day.

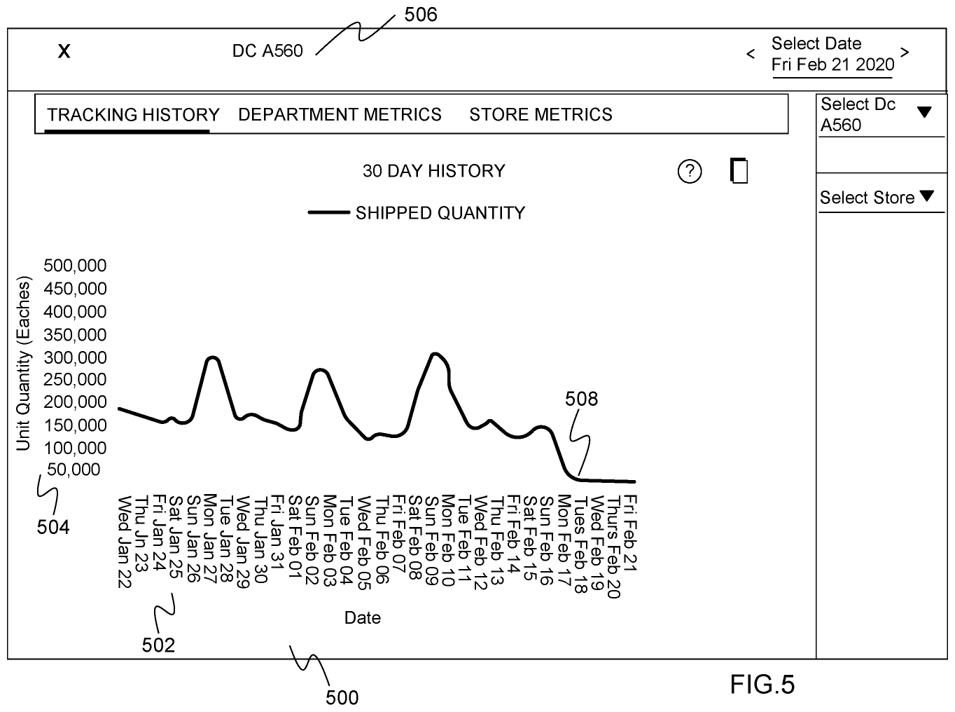

FIG. 5 shows an example user interface 500 showing days on horizontal axis 502 and total number of units on vertical axis 504. A header 506 identifies the destination. A graph 508 depicts how the number of shipped units vary over the last thirty days. At step 310, the shipments are examined to determine if the shipments to the destination have changed recently or if the shipments are within the historical range for the destination. Examining graph 508, it can be seen that the shipments drop rapidly on date 510. This indicates that something may have happened that caused the shipments to the destination to drop.

At step 312, to determine what caused the shipments to drop, the user requests a user interface that shows the expected inventory level (OTL), order requests, transfer orders and shipments for the destination for the past thirty days. At step 314, user interface generator 114 requests the unit quantities for OTL, order requests, transfer orders and shipments for the destination for the past thirty days from data access API 120. User interface generator 114 then displays a user interface showing the number of units for OTL, order requests, transfer orders and shipments for the past thirty days provided by data access API 120.

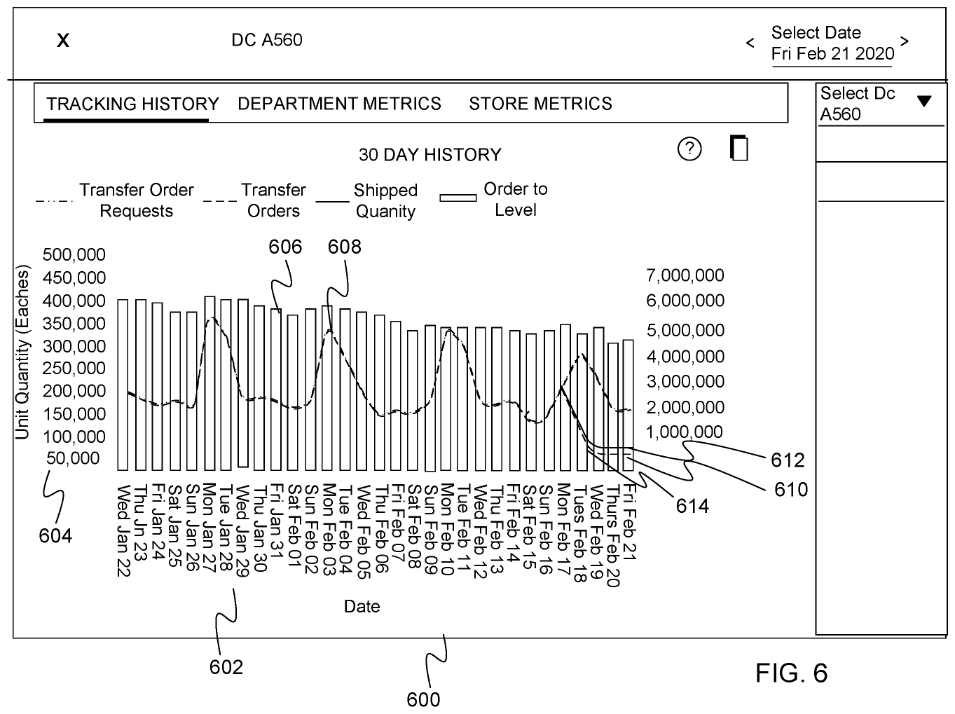

FIG. 6 shows an example user interface 600 that shows the number of units for OTL, order requests, transfer orders and shipments for a destination for the past thirty days. In FIG. 6, days are shown along horizontal axis 602 and the number of units is shown along vertical axis 604. OTL is shown as bars, such as bar 606, order requests are shown by graph 608, transfer orders are shown by graph 610, and shipped units are shown by graph 612.

At step 316, the user interface is examined to determine when a low unit count first appeared in the supply chain systems. As shown in FIG. 6, the drop in shipped units is associated with a similar drop in transfer orders on day 614. This drop in units for transfer orders does not track the order requests. This indicates that there may be a problem with the transfer order constructor system.

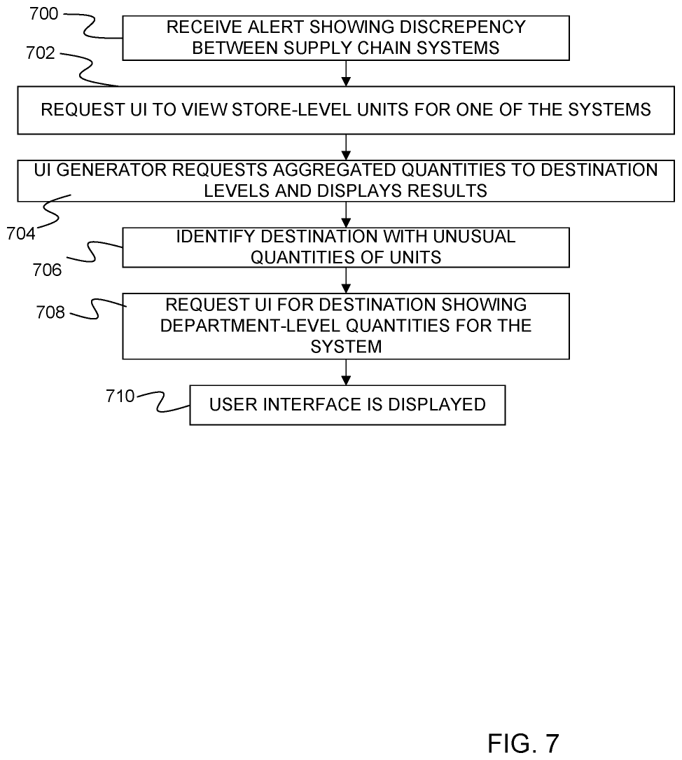

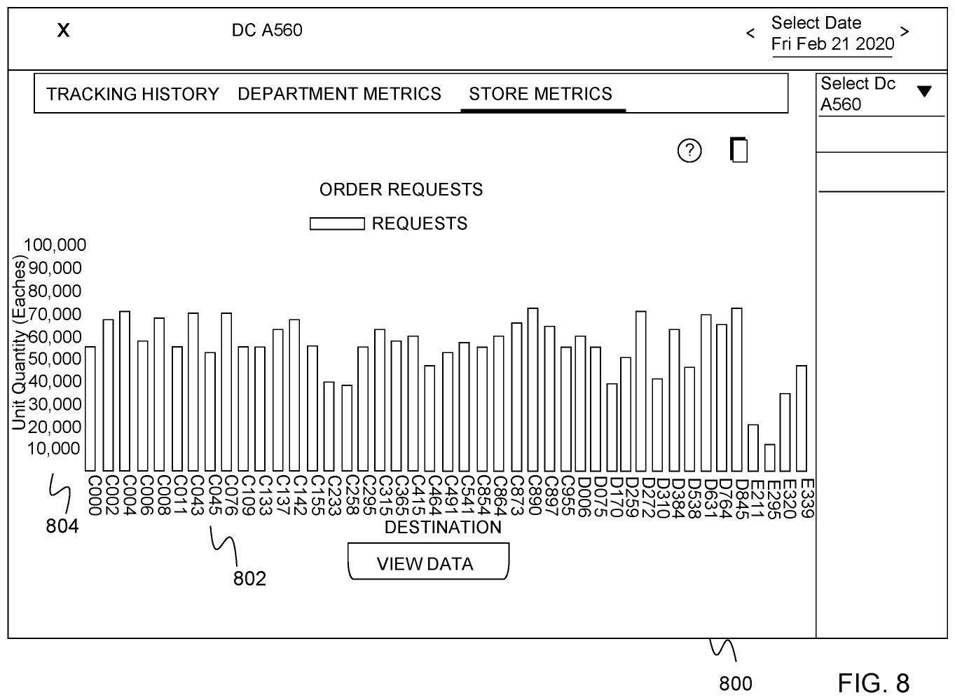

FIG. 7 provides a flow diagram of a method of identifying which department of a destination has erroneous data associated with it. At step 700, an alert is received indicating a discrepancy between two supply chain systems at a distribution center level. At step 702, a user interface is requested to view destination-level unit quantities for one of the systems. In response, user interface generator 114 requests aggregate unit quantities for all of the items assigned to each destination at step 704. User interface generator 114 then displays the destination-level unit quantities for the destinations serviced by the distribution center. FIG. 8 provides an example of a user interface 800 showing destination-level unit quantities associated with order requests produced by replenishment engines. In FIG. 8, destinations are shown along horizontal axis 802 and unit quantities are shown along vertical axis 804.

At step 706, a destination with an unusual number of units is identified and at step 708, one of the destinations shown in the user interface of step 704 is selected and a user interface for the destination is requested. In particular, a user interface showing unit quantities for individual departments in the selected destination is requested. At step 710, the user interface is displayed.

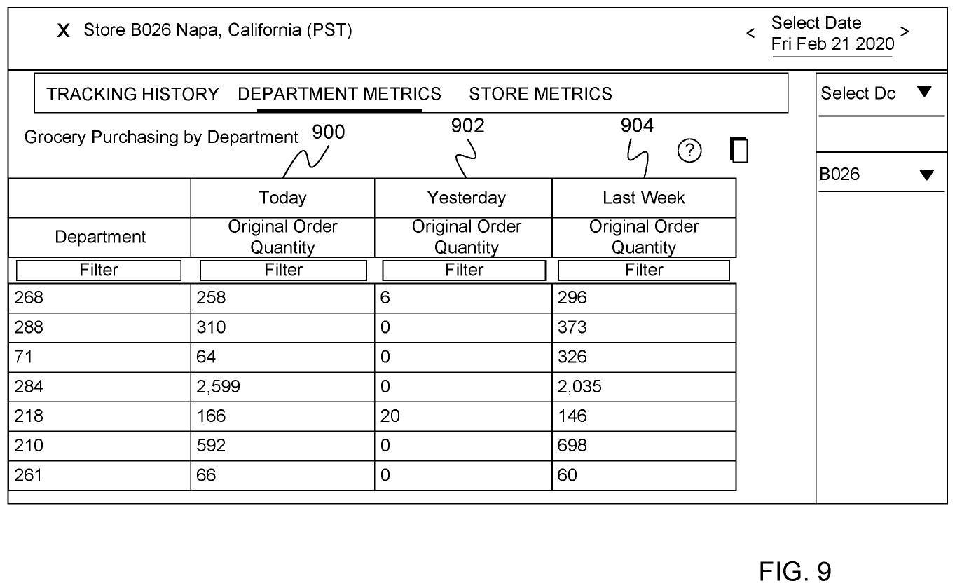

FIG. 9 provides an example of a user interface displayed at step 710. In FIG. 9, unit quantities for transfer order requests are shown for three different days 900, 902, and 904. For each day, the unit quantities have been aggregated at a department level so that the number of units ordered for each department on each day can be viewed.

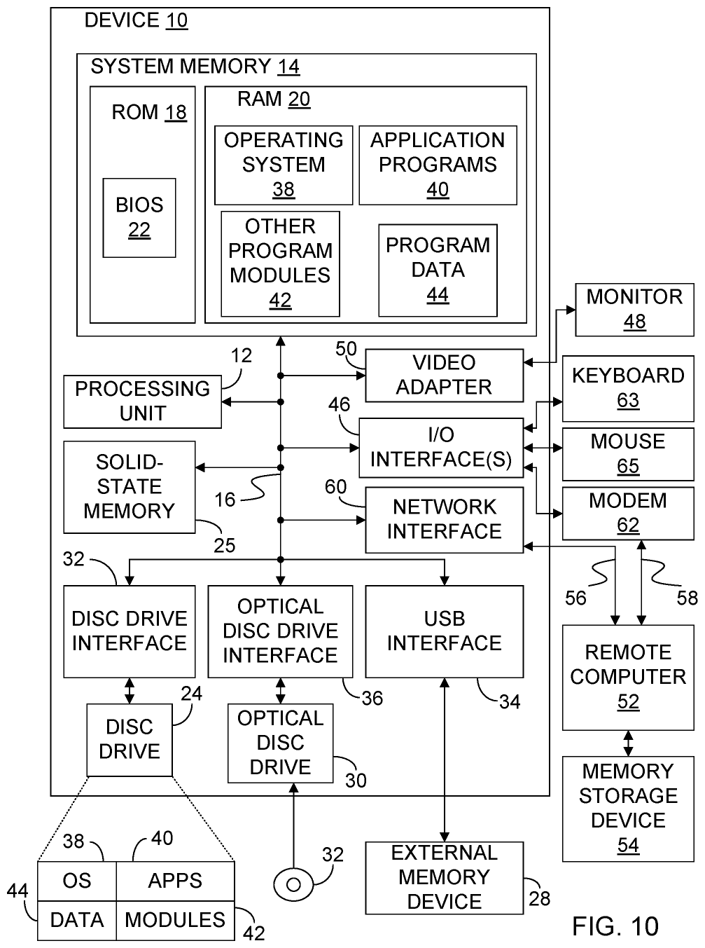

The supply chain monitoring system discussed above is implemented on a computing device, an example of which is shown in FIG. 10. Computing device 10 of FIG. 10 includes a processing unit 12, a system memory 14 and a system bus 16 that couples the system memory 14 to the processing unit 12. System memory 14 includes read only memory (ROM) 18 and random-access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Computing device 10 further includes an optional hard disc drive 24, an optional external memory device 28, and an optional optical disc drive 30. External memory device 28 can include an external disc drive or solid-state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing any one of the applications discussed above. Program data 44 may include any data used by the systems and methods discussed above.

Processing unit 12, also referred to as a processor, executes programs in system memory 14 and solid-state memory 25 to perform the methods described above.

Input devices including a keyboard 63 and a mouse 65 are optionally connected to system bus 16 through an Input/Output interface 46 that is coupled to system bus 16. Monitor or display 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 10. The network connections depicted in FIG. 10 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 10 are exemplary and other means for establishing a communications link between the computers, such as a wireless interface communications link, may be used.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
receiving values for different keys from different systems in a supply chain;
determining a difference between a value for a first key from a first system and a value for a second key from a second system and comparing the difference to an alert threshold; and
issuing an alert when the difference exceeds the alert threshold.

2. The computer-implemented method of claim 1 wherein determining the difference comprises constructing the value for the first key by aggregating multiple values for the first key.

3. The computer-implemented method of claim 2 wherein aggregating multiple values comprises summing values provided for a plurality of individual items for each of a plurality of locations.

4. The computer-implemented method of claim 1 further comprising:
determining a difference between a value for the first key from the first system at a first time and a value for the first key from the first system at a second time;
comparing the difference to a second alert threshold; and
issuing a second alert when the difference exceeds the second alert threshold.

5. The computer-implemented method of claim 4 wherein the first system is incapable of determining the difference between the value for the first key at the first time and the value for the first key at a second time.

6. The computer-implemented method of claim 4 wherein the difference between the value for the first key from the first system at the first time and the value for the first key from the first system at a second time is caused by erroneous information provided by a third system in the supply chain.

7. The computer-implemented method of claim 1 further comprising:
setting a time when a value for the first key is expected from the first system;
determining that the value for the first key has not been received from the first system; and
issuing an alert to indicate that the value for the first key has not been received.

8. A supply chain monitoring system comprising:
a message intake accessing key/value pairs generated by a plurality of systems in a supply chain for purposes other than monitoring the supply chain;
a data storage system storing the key/value pairs in a random access memory;
an alert service requesting values from the random access memory and using the requested values to determine whether key/value pairs from a first system in the plurality of systems and key/value pairs from a second system in the plurality of systems indicate that an alert condition exists in the supply chain.

9. The supply chain monitoring system of claim 8 wherein the alert service further generates an alert when key/value pairs have not been received from one of the plurality of systems.

10. The supply chain monitoring system of claim 8 further comprising an aggregator that forms aggregate values from the key/value pairs and wherein the data storage system stores the aggregate values in the random access memory and the alert service requests the aggregate values.

11. The supply chain monitoring system of claim 10 wherein forming an aggregate value comprises summing values provided for a plurality of individual items for each of a plurality of locations.

12. The supply chain monitoring system of claim 8 wherein the alert system further uses the requested values to determine whether key/value pairs from the first system at a first time and key/value pairs from the first system at a second time indicate that an alert condition exists in the supply chain.

13. The supply chain monitoring system of claim 12 wherein the first system is incapable of determining that an alert condition exists in the supply chain based on the key/value pairs at the first time and the key/value pairs at the second time.

14. The supply chain monitoring system of claim 12 wherein the alert condition is caused by erroneous information provided by a third system in the supply chain.

15. A method comprising:
storing data in random access memory from multiple systems in a supply chain;
executing an alert service that sets an alert when one of the multiple systems has not provided key/value pairs associated with a supply chain process performed by the system.

16. The method of claim 15 wherein the alert service further:
uses the data stored in the random access memory to determine when key/value pairs provided by a first system of the multiple systems and key/value pairs provided by a second system of the multiple systems indicate that an alert condition exists in the supply chain.

17. The method of claim 16 wherein the key in the key/value pairs provided by the first system differs from the key in the key/value pairs provided by the second system.

18. The method of claim 16 wherein storing data in random access memory comprises aggregating values in the key/value pairs provided by the first system to produce an aggregated value and storing the aggregated value in random access memory and wherein the alert service uses the aggregated value to determine when an alert condition exists.

19. The method of claim 18 wherein aggregating values comprises aggregating values for a plurality of different items associated with a plurality of different locations.

20. The method of claim 15 wherein the alert service further:
uses the data stored in the random access memory to determine when key/value pairs provided by a first system at a first time and key/value pairs provided by the first system at a second time indicate that an alert condition exists in the supply chain.
